(19) United States
(12) Patent Application Publication
(10) Pub. No.: US 2014/0310501 A1
(43) Pub. Date: Oct. 16, 2014

(54) APPARATUS AND METHOD FOR CALCULATING PHYSICAL ADDRESS OF A PROCESSOR REGISTER

(71) Applicant: SAMSUNG ELECTRONICS CO., LTD., Suwon-si (KR)

(72) Inventor: Tai-Song JIN, Seoul (KR)

(73) Assignee: SAMSUNG ELECTRONICS CO., LTD., Suwon-si (KR)

(21) Appl. No.: 14/248,731

(22) Filed: Apr. 9, 2014

(30) Foreign Application Priority Data
Apr. 10, 2013 (KR) 10-2013-0039406

(51) Int. Cl. G06F 12/10

(52) U.S. Cl. CPC G06F 12/10; G06F 2212/657
USPC 711/206

(57) ABSTRACT

An apparatus and method for calculating a physical address of a register in a processor are provided. The apparatus includes an offset calculator configured to calculate an offset between the physical address and a logical address of the register, based on a current iteration number and a size of a rotating register; an address calculator configured to calculate the physical address of the register by adding the calculated offset to the logical address of the register; and an address corrector configured to output a final physical address of the register based on the calculated physical address and the size of the rotating register.

### CROSS-REFERENCE TO RELATED APPLICATION

This application claims priority from a Korean Patent Application No. 10-2013-0039406, filed on Apr. 10, 2013, in the Korean Intellectual Property Office, the entire disclosure of which is incorporated herein by reference for all purposes, in its entirety.

### BACKGROUND

1. Technical Field

The following description relates to an apparatus and a method for calculating a physical address of a register in a processor.

2. Description of the Related Art

A central register file in a coarse-grained reconfigurable architecture (CGRA) of the related art is divided into a non-rotating register file and a rotating register file, to respectively store live-in and live-out values, and temporal values. The non-rotating register file is used for storing the live-in and live-out values, and the rotating register file is used for storing the temporal values.

Generally, sizes of the rotating register and the non-rotating register are determined in a hardware design. At this time, the size of the rotating register is determined in the form of a power of two. When applying a software pipelining technique for a program loop in a CGRA-based processor, since a life time of the same variable is overlapped in different iterations, a collision problem of the register can occur. To solve this problem, different physical addresses are practically allotted even when logical addresses of the registers are the same. This is for easily performing a modulo calculation used in a general physical address calculation method when the processor calculates a physical address using a logical address of the register.

However, the size of the non-rotating register can be insufficient, according to the live-in/out value of the program loop. The result is that performance may be reduced. Accordingly, it is necessary to dynamically determine the sizes of the rotating register and the non-rotating register in a run-time. At this time, in response to the size of the rotating register not being in the form of the second power, the modulo calculation of the general address calculation method used for calculating a physical address becomes very difficult, and this results in a reduction in performance.

### SUMMARY

The following description relates to an apparatus and a method for calculating a physical address of a register, which can improve performance of a processor by calculating a physical address of a rotating register at a high speed even when the size of the rotating register is not in the form of a power of two.

In one general aspect, an apparatus for calculating a physical address of a register, includes: an offset calculator configured to calculate an offset between the physical address and a logical address of the register based on the current iteration number and a size of a rotating register; an address calculator configured to calculate the physical address of the register by adding the calculated offset to the logical address of the register; and an address corrector configured to output a final physical address of the register based on the calculated physical address and the size of the rotating register.

The offset calculator may calculate the offset by adding a predetermined value to a previous offset in response to the current iteration number being changed.

In response to the calculated offset being equal to the size of the rotating register, the offset calculator may reset the calculated offset.

The address corrector may compare the calculated physical address and the size of the rotating register, and determine that correction is necessary in response to the calculated physical address being greater than the size of the rotating register.

In response to the address corrector determining that the correction is necessary, the address corrector may subtract the size of the rotating register from the calculated physical address and may output the value as the final physical address.

In response to the address corrector determining that the correction is not necessary, the address corrector may output the calculated physical address as the final physical address.

The size of the rotating register may be variably determined for each program loop in a compiling step of a program.

In a compiling step of a program, the rotating register may be dynamically allotted to at least one of a central register file and a local register file of a processor.

In another general aspect, a method of calculating a physical address of a register includes: calculating an offset between the physical address and a logical address of the register, based on the current iteration number and a size of a rotating register; calculating the physical address of the register by adding the calculated offset to the logical address of the register; and outputting a final physical address of the register based on the calculated physical address and the size of the rotating register.

The calculating of the offset may include calculating the offset by adding a predetermined value to a previous offset in response to the current iteration number being changed.

In response to the calculated offset being equal to the size of the rotating register, the calculating of the offset may include resetting the calculated offset.

The outputting of the final physical address may include: comparing the calculated physical address and the size of the rotating register; and determining whether correction of the calculated physical address is necessary based on the result of the comparison.

The outputting of the final physical address may further include subtracting the size of the rotating register from the calculated physical address and outputting the value as the final physical address in response to the correction being necessary.

The outputting of the final physical address may further include outputting the calculated physical address as the final physical address, in response to the correction not being necessary.

The size of the rotating register may be variably determined for each program loop in a compiling step of a program.

The rotating register may be dynamically allotted to at least one of a central register file and a local register file of a processor, in a compiling step of a program.

An aspect of an exemplary embodiment may provide an apparatus for calculating a physical address of a register, the apparatus comprising: an offset calculator configured to calculate an offset between the physical address and a logical address of the register; an address calculator configured to calculate the physical address of the register; and an address corrector configured to output a final physical address of the register.

The offset may be calculated based on a current iteration number and a size of a rotating register.

The physical address may be calculated by adding the calculated offset to the logical address of the register.

In addition, the final physical address may be output by adding the calculated offset to the logical address of the register.

Other features and aspects will be apparent from the following exemplary embodiments, the drawings, and the claims.

### BRIEF DESCRIPTION OF THE DRAWINGS

FIG. 1 is a diagram illustrating an example of a CGRA-based processor.

FIGS. 2A and 2B are diagrams which explain a software pipelining technique supported by a rotating register.

FIG. 3 is a block diagram of an apparatus for calculating a physical address of a register, according to an exemplary embodiment.

FIG. 4 is a diagram which explains an operation performed in an apparatus for calculating a physical address of a register, according to an exemplary embodiment.

FIG. 5 is a flowchart which illustrates a method of calculating a physical address of a register, according to an exemplary embodiment.

FIG. 6 is a detailed flowchart which illustrates a method of calculating a physical address of a register, according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE EXEMPLARY EMBODIMENTS

The following description is provided to assist the reader in gaining a comprehensive understanding of the methods, apparatuses, and/or systems described herein. Accordingly, various changes, modifications, and equivalents of the methods, apparatuses, and/or systems described herein will be obvious to those of ordinary skill in the art. Also, descriptions of well-known functions and constructions may be omitted for increased clarity and conciseness.

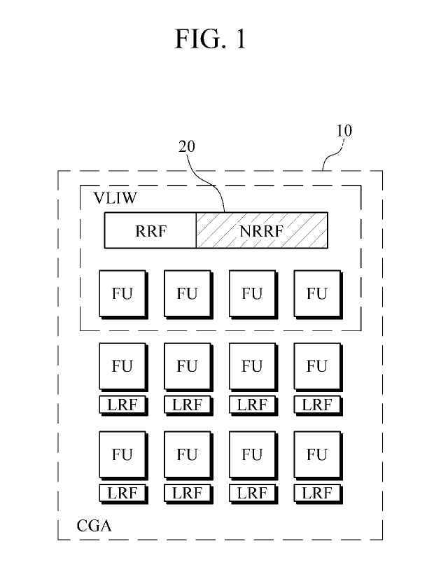

FIG. 1 is a diagram illustrating an example of a CGRA-based processor.

Referring to FIG. 1, a processor 10 includes a plurality of function units FU arranged in an array with rows and columns, a central register file 20, and a local register file LRF corresponding to each function unit FU. The reconfigurable processor 10 may operate as a processor having very long instruction word VLIW and coarse grained array CGA modes by sharing the central register file 20.

As shown in FIG. 1, the central register file 20 is divided into a rotating register file RRF and a non-rotating register file NRRF. In response to the processor 10 operating in the CGA mode, generally, live-in and live-out values are stored in the non-rotating register file NRRF and temporal values are stored in the rotating register file RRF.

Generally, sizes of the rotating register file RRF and the non-rotating register file NRRF are determined in a step of the architecture design of the processor 10, and at this time, the size of the rotating register file RRF may be determined in the form of a power of two in order to easily perform a modulo calculation used for calculating a physical address.

However, since the size of the rotating register and the size of non-rotating register which are required for each program loop, are different, there is a problem in that predetermined sizes of a rotating register or non-rotating register are insufficient, according to the program loop. To solve this problem, it is necessary to dynamically determine the sizes of the rotating register and the non-rotating register, according to the program loop in a run-time.

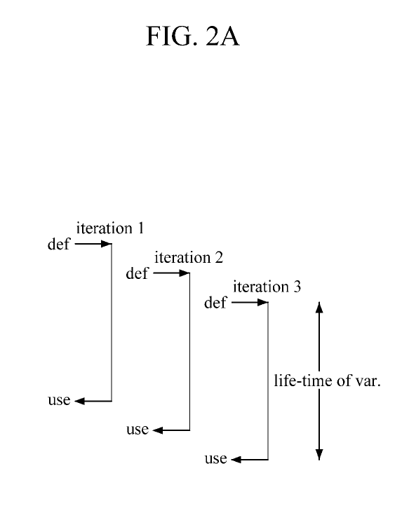

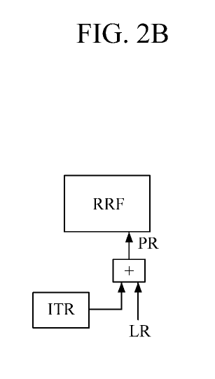

FIGS. 2A and 2B are diagrams for explaining a rotating register file supporting a software pipelining technique.

Referring to FIGS. 1 and 2B, in order to effectively process a program loop having a predetermined number of iterations, the CGRA-based processor 10 uses a scheduling method of processing according to different parallel iterations by applying a software pipelining technique instead, of sequentially processing each iteration.

As shown in FIG. 2A, since iterations 1, 2 and 3 are performed in parallel, a life time of the same variable is overlapped, and thus a collision problem of the central register 20 may occur. For example, when a variable defined at a start of the iteration 1 is used at the end of the iteration 1, the variable is stored in the central register 20. However, since a life time of the variable stored in the central register 20 is overlapped in the iterations 1, 2, and 3, a value of the variable generated in iteration 1 may be changed in the iterations 2 or 3. Accordingly, in response to the value of the variable being used at the end of the iteration 1, there is a problem in that different values changed in the iterations 2 or 3 are used.

To solve this problem, a method of defining the rotating register file RRF in the central register 20 is generally used. For example, the current iteration number ITR is added to an address of a logical register LR defined as shown in FIG. 2B, and an added value is used as an address of a physical register PR. In response to using the value of the variable in each iteration, the problem can be solved by using the value of the variable stored in the address of the physical register PR.

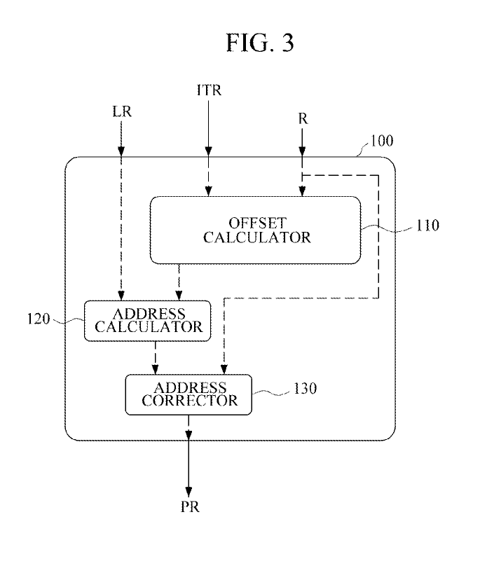

FIG. 3 is a block diagram of an apparatus for calculating a physical address of a register, according to an exemplary embodiment.

The apparatus for calculating the physical address of the register 100 according to an exemplary embodiment can be applied to not only a general processor determining the size of the rotating register and the size of the non-rotating register in an architecture design step, but can also be applied to a processor dynamically determining the size of the rotating register and the size of the non-rotating register in a run-time.

Referring to FIG. 3, the apparatus for calculating the physical address of the register 100 includes an offset calculator 110, an address calculator 120, and an address corrector 130.

The offset calculator 110 calculates an offset between a logical address and a physical address of the register based on the current iteration number and the size of the rotating register. At this time, the size of the rotating register may be previously determined in an architecture design step.

In response to the sizes of the rotating register and the non-rotating register of the processor 10 as shown in FIG. 1 being designed to dynamically determine each program loop in a compiling step, the size of the rotating register may be dynamically and variably determined for each program loop in the compiling step of the program. At this time, a scheduler may determine the sizes of the non-rotating registers and the rotating register based on the live-in and the live-out values for each program loop.

According to an additional aspect of the exemplary embodiments, the rotating register and the non-rotating register of the processor 10 are designed, as shown in FIG. 1, to be allotted to not only the central register file 20 but also the local register file LRF in the compiling step, the rotating register may be allotted to at least one of the central register file 20 and the local register file LRF.

The offset calculator 110 calculates an offset by adding a predetermined value to a previously calculated offset in response to the input current iteration number being changed. At this time, in response to the calculated offset being equal to the size of the rotating register, the calculated offset may be reset to an initial value.

The address calculator 120 calculates an address of the physical register PR by adding the offset calculated in the offset calculator 110 to an input address of the logical register LR.

The address corrector 140 determines whether or not correction of the physical address calculated by the address calculator 120 is needed. In response to correction being necessary, the address corrector 140 corrects the calculated physical address to output a final physical address, and in response to correction not being necessary, the address corrector 140 outputs the calculated physical address as the final physical address.

At this time, the address corrector 140 may determine whether correction is necessary by comparing the calculated physical address and the size of the rotating register. For example, in response to the calculated physical address being greater than the size of the rotating register, the address corrector 140 may determine that the correction is necessary. In response to correction being necessary, the address corrector 140 may subtract the size of the rotating register from the calculated physical address and output the value as the final physical address.

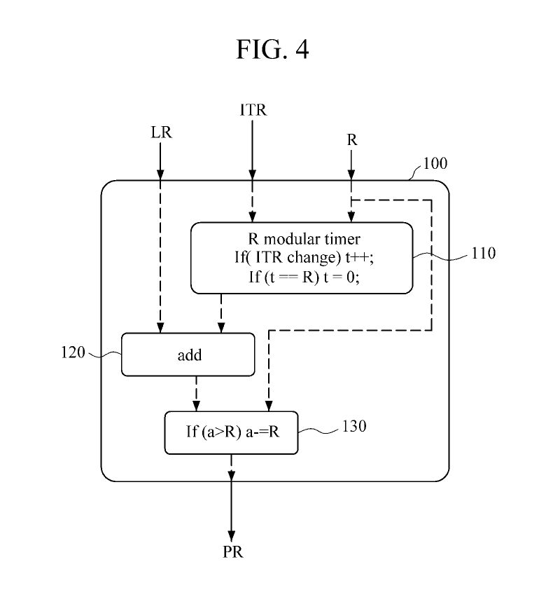

FIG. 4 is a diagram for explaining a calculation performed in an apparatus for calculating a physical address of a register, according to an exemplary embodiment.

FIG. 4 illustrates a procedure where the apparatus for calculating the physical address of the register 100 calculates the physical address according to the following equation 1.

PR={(LR+ITR%R)%R} [Equation 1]

Here, PR represents an address of a physical register, LR an address of a logical register, ITR the current iteration number, R the size of the rotating register, and % a modulo calculation for obtaining the remainder.

The offset calculator 110 inputs the current iteration number ITR and the determined size of the rotating register R in order to perform the modulo calculation to calculate an offset between the address of the physical register PR, and the address of the logical register LR.

The address calculator 120 calculates the physical address by adding the modulo calculation result of the offset calculator 110. That is, the calculated offset and the address of the logical register LR.

The address corrector 130 performs the modulo calculation on the calculated physical address as the size of the rotating register to output the final physical address.

For example, the offset calculator 110 defines a variable t representing an offset, sets the variable t representing the offset as an initial value (for example: 0), and increases the variable t by a predetermined size (for example: 1) whenever the current iteration number is changed. After this, the offset calculator 110 checks whether the variable t is equal to the size of the rotating register. In response to the variable t being equal to the size of the rotating register, the offset calculator 110 resets the variable t as the initial value (for example: 0).

The address calculator 120 adds the input address of the logical register LR and the calculated offset variable t, and stores a variable ‘a’ representing the physical address.

The address corrector 130 compares the calculated variable ‘a’ and the size of the rotating register R, and determines whether a correction is necessary. At this time, in response to the calculated variable a being greater than the size of the rotating register R, the address corrector 130 determines that the correction is necessary, subtracts the size of the rotating register R from the calculated variable ‘a,’ and stores the value as a new variable ‘a’ representing the physical address to output the final physical address. On the other hand, in response to the address corrector 130 determining that correction is not necessary, the address corrector 130 outputs the calculated variable ‘a’ as the final physical address.

Likewise, according to an exemplary embodiment, the sizes of the rotating register and the non-rotating register may be dynamically determined in a compiling step, and the physical address can be calculated at a high speed and performance of the processor is improved, even when the size of the rotating register is not in the form of a power of two.

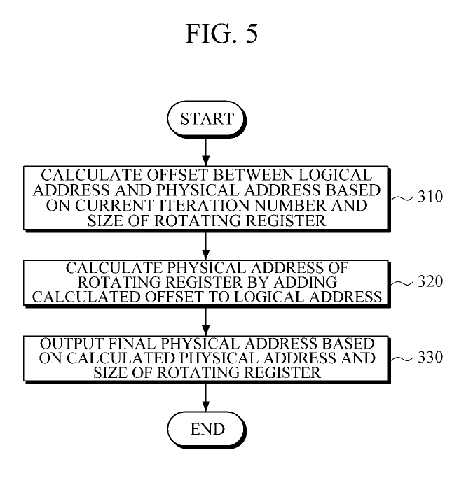

FIG. 5 is a flowchart which illustrates a method of calculating a physical address of a register, according to an exemplary embodiment.

Referring to FIG. 5, the method of calculating the physical address of the register using the apparatus for calculating the physical address of the register, according to an exemplary embodiment of FIG. 3 will be explained below.

Firstly, an offset between a logical address and a physical address of the register is calculated based on the current iteration number and the size of the rotating register (operation 310). At this time, the size of the rotating register may be previously determined in an architecture design step, or dynamically determined for each program loop in a compiling step as described above. Further, the rotating register is allotted to not only the central register file 20 but also to the local register file LRF, in some cases.

Thereafter, an address of a physical register PR is calculated by adding the calculated offset an address of the logical register LR (operation 320).

Then, a final physical address based on the calculated physical address and the size of the rotating register is output (operation 330). For example, the apparatus for calculating the physical address of the register 100 compares the calculated physical address and the size of the rotating register, and determines whether correction of the physical address is necessary, based on the result of the comparison. At this time, in response to the correction being necessary, the physical address is corrected according to a predetermined rule, and the corrected physical address is output as a final physical address. On the other hand, in response to the correction not being necessary, the calculated physical address is output as the final physical address.

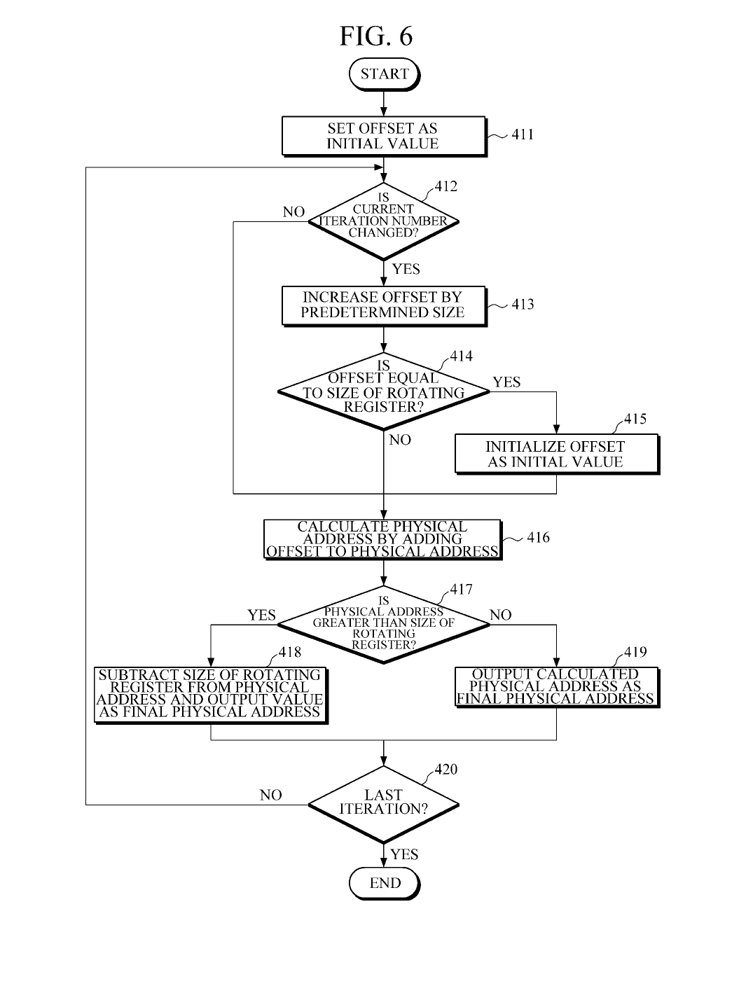

FIG. 6 is a detailed flowchart which illustrates a method of calculating a physical address of a register, according to an exemplary embodiment.

The method of calculating the physical address of the register according to an exemplary embodiment will be explained below with reference to FIG. 6.

The apparatus for calculating the physical address of the register sets an offset as an initial value (for example: 0) (operation 411). After this, a check is performed to determine whether the current iteration number is changed (operation 412), and in response to the current iteration number being changed, the offset is increased by a predetermined size (for example: 1) (operation 413), whereas, in response to the current iteration number is not changed, the process proceeds to operation 416 of calculating a physical address since the offset is equal to the previously calculated offset.

After this, a check is performed to determine whether the calculated offset is equal to the size of the rotating register (operation 414), and the offset is initialized in response to the calculated offset being equal to the size of the rotating register (operation 415).

Thereafter, an address of the physical register PR is calculated by adding the address of the logical register LR to the calculated offset (operation 416).

Then, the calculated physical address and the size of the rotating register are compared to determine whether correction of the physical address is necessary (operation 417). That is, in response to the calculated physical address being greater than the size of the rotating register, the correction is determined to be necessary, and if not, the correction is determined to not be necessary.

In response to the correction being determined as necessary in operation 417, the size of the rotating register is subtracted from the calculated physical address and the value is output as a final physical address (operation 418). On the other hand, in response to the correction is determined to not be necessary in operation 417, the physical address calculated in operation 416 is output as the final physical address (operation 419).

Thereafter, a determination is made as to whether a current iteration is the last iteration (operation 420), and in response to the current iteration being the last iteration, that is, every iteration with respect to every program loop is completed, the method ends. If every iteration is not ended, the process returns to operation 412.

The exemplary embodiments can be implemented as computer readable codes in a non-transitory computer readable record medium. The computer readable record medium includes all types of record media in which computer readable data is stored.

Examples of the computer readable record medium include a ROM, a RAM, a CD-ROM, a magnetic tape, a floppy disk, and an optical data storage device. Further, the record medium may be implemented in the form of carrier waves such as an Internet transmission. In addition, the computer readable record medium may be distributed to computer systems over a network, in which computer readable codes may be stored and executed in a distributed manner. Functional programs, codes, and code segments for implementing exemplary embodiments may be easily conceived of by a programmer of ordinary skill in the art.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented with other components or their equivalents. Accordingly, the exemplary embodiments should not be considered as limiting, and other implementations are within the scope of the following claims.

What is claimed is:

1. An apparatus for calculating a physical address of a register, the apparatus comprising:
an offset calculator configured to calculate an offset between the physical address and a logical address of the register, based on a current iteration number and a size of a rotating register;
an address calculator configured to calculate the physical address of the register by adding the calculated offset to the logical address of the register; and
an address corrector configured to output a final physical address of the register based on the calculated physical address and the size of the rotating register.

2. The apparatus according to claim 1, wherein the offset calculator is configured to calculate the offset by adding a predetermined value to a previous offset in response to the current iteration number being changed.

3. The apparatus according to claim 2, wherein the offset calculator is configured to reset the calculated offset, in response to the calculated offset being equal to the size of the rotating register.

4. The apparatus according to claim 1, wherein the address corrector is configured to compares the calculated physical address and the size of the rotating register, and determine that correction is necessary in response to the calculated physical address being greater than the size of the rotating register.

5. The apparatus according to claim 4, wherein the address corrector is configured to correct the size of the rotating register from the calculated physical address and output a resulting value as the final physical address, in response to the address corrector determining that the correction is necessary.

6. The apparatus according to claim 4, wherein the address corrector is configured to output the calculated physical address as the final physical address, in response to the address corrector determining that the correction is not necessary.

7. The apparatus according to claim 1, wherein the size of the rotating register is variably determined for each program loop, in a compiling step of a program.

8. The apparatus according to claim 1, wherein the rotating register is dynamically allotted to at least one of a central register file and a local register file of a processor, in a compiling step of a program.

9. A method of calculating a physical address of a register, comprising:
calculating an offset between the physical address and a logical address of the register based on a current iteration number and a size of a rotating register;
calculating the physical address of the register by adding the calculated offset to the logical address of the register; and
outputting a final physical address of the register based on the calculated physical address and the size of the rotating register.

10. The method according to claim 9, wherein the calculating of the offset comprises calculating the offset by adding a predetermined value to a previous offset in response to the current iteration number being changed.

11. The apparatus according to claim 10, wherein the calculating of the offset comprises resetting the calculated offset, in response to the calculated offset being equal to the size of the rotating register.

12. The method according to claim 9, wherein the outputting of the final physical address comprises:
comparing the calculated physical address and the size of the rotating register; and
determining whether correction of the calculated physical address is necessary, based on the result of the comparison.

13. The method according to claim 12, wherein the outputting of the final physical address further comprises, subtracting the size of the rotating register from the calculated physical address and outputting a resulting value as the final physical address, in response to correction of the calculated physical address being necessary.

14. The method according to claim 12, wherein the outputting of the final physical address further comprises outputting the calculated physical address as the final physical address, in response to correction of the calculated physical address not being necessary.

15. The method according to claim 9, wherein the size of the rotating register is variably determined for each program loop in a compiling step of a program.

16. The method according to claim 9, wherein the rotating register is dynamically allotted to at least one of a central register file and a local register file of a processor in a compiling step of a program.

17. An apparatus for calculating a physical address of a register, the apparatus comprising:
an offset calculator configured to calculate an offset between the physical address and a logical address of the register;
an address calculator configured to calculate the physical address of the register; and
an address corrector configured to output a final physical address of the register.

18. The apparatus according to claim 17, wherein the offset is calculated based on a current iteration number and a size of a rotating register.

19. The apparatus according to claim 17, wherein the physical address is calculated by adding the calculated offset to the logical address of the register.

20. The apparatus according to claim 17, wherein the final physical address is output by adding the calculated offset to the logical address of the register.
